(19) United States
(12) Patent Application Publication
(10) Pub. No.: US 2016/0203561 A1
(43) Pub. Date: Jul. 14, 2016

(54) MODULARLY CONFIGURABLE VISUAL REPRESENTATION OF POLICY COVERAGE

(71) Applicant: ESURANCE INSURANCE SERVICES, INC., San Francisco, CA (US)

(72) Inventors: Peter Olof Peterson, IV, San Rafael, CA (US); Ram Gabriel Lukas, Roseville, CA (US); Maureen Kelly, Rocklin, CA (US); Edgar Jesus Gutierrez Vega, Dublin, CA (US)

(73) Assignee: Esurance Insurance Services, Inc.

(21) Appl. No.: 14/996,020

(22) Filed: Jan. 14, 2016

Related U.S. Application Data
(60) Provisional application No. 62/103,519, filed on Jan. 14, 2015.

(51) Int. Cl. G06Q 40/08

(52) U.S. Cl. CPC G06Q 40/08

(57) ABSTRACT

A system, a method, and a computer program product for generating a visual representation of an insurance policy coverage are disclosed. At least one visual representation of an object for which an insurance coverage is desired is generated. The visual representation is generated based on a data, received over a communications network, describing the object. The data contains a plurality of attributes associated with the object. The visual representation graphically represents the object and at least one attribute in the plurality of attributes. At least one insurance policy quote for insuring the object is generated. The visual representation and the generated insurance policy quote are transmitted to at least one user device. The visual representation and the generated insurance policy quote are displayed using at least one user interface caused to be generated by the user device.

### CROSS-REFERENCE TO RELATED APPLICATIONS

This application claims priority to U.S. Provisional Patent Application No. 62/103,519 to Peter Olof Peterson IV et al., filed Jan. 14, 2015 and entitled “Modularly Configurable Visual Representation Of Policy Coverage,” and incorporates its disclosure herein by reference in its entirety.

### TECHNICAL FIELD

In some implementations, the current subject matter generally relates to data processing and, in particular, to modularly configurable visual representation of policy coverage.

### BACKGROUND

Customers generally insure property and/or items (e.g., vehicles, belongings, etc.) with an insurance provider. The insurance provider generates an insurance policy that represents an agreement between the insurance provider and customer relating to insurance coverage for the insured items. In conventional approaches, the insurance provider delivers a document to the customer that contains information relating to the insurance policy. The document generally contains several lists of items associated with the insurance coverage. The insurance provider enables the customer to access a web-based representation of the insurance policy through a web client (e.g., a web browser, an application), although the insurance policy is presented to the user in text format similar to the document. As such, the text-based representation of the insurance policy can cause the customer to have an incomplete understanding of the insured items and can adversely impact the customer's experience through an insurance policy management process.

In certain instances, the insurance policy may be incomplete and/or contain irrelevant information relating to the item being insured. For example, it may be difficult to determine value of the item after damage has been sustained to it and whether such damage is covered by the policy due to customer's not understanding the textual form of the policy. As such, any unnecessary delay or incomplete understanding of the policy can adversely impact the customer's understanding of the coverages and/or experience through the insurance claims process.

### SUMMARY

In some implementations, the current subject matter relates to a computer-implemented method for generating a visual representation of an insurance policy coverage. The method can include generating at least one visual representation of an object for which an insurance coverage is desired, wherein the visual representation is generated based on a data, received over a communications network, describing the object, the data containing a plurality of attributes associated with the object, the visual representation graphically representing the object and at least one attribute in the plurality of attributes, generating at least one insurance policy quote for insuring the object, transmitting the visual representation and the generated insurance policy quote to at least one user device, and displaying the visual representation and the generated insurance policy quote using at least one user interface generated by the user device. At least one of the generating the visual representation, the generating the insurance policy quote, the transmitting, and the displaying can be performed by at least one processor of at least one computing system. In some implementations, the insurance coverage can be for an existing object (e.g., property, vehicle, etc.), where a user can see what the coverages are and what has been covered. Alternatively, the insurance coverage can be for an entirely new object, i.e., one that has not yet been insured by the insurance company.

In some implementations, the current subject matter can include one or more of the following optional features. The method can further include verifying the data describing the object. The object can includes at least one of the following: a tangible object, an intangible object, a real property, a personal property, a vehicle, a motorcycle, a residential property, an industrial property, a jewelry, a painting, and any combination thereof. The data describing the object can include at least one of the following: a video data, an audio data, a text data, a photographic data, and any combination thereof.

In some implementations, the method can also include receiving changes to the data describing the object, generating, based on the received changes, a new visual representation and a new insurance policy quote, and transmitting the new visual representation and the new insurance policy quote to the user device.

In some implementations, the user interface can include at least one of the following: a data describing the object, a data describing at least one attribute in the plurality of attributes, a graphical representation of the object, a graphical representation of at least one attribute in the plurality of attributes, a video illustrating the object and/or at least one attribute in the plurality of attributes, a narrative textual data describing the object, and any combination thereof.

In some implementations, the transmission of the visual representation can include transmitting at least one option for obtaining additional insurance coverage for the object.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates an exemplary system for visualizing an insurance policy for insuring an object, according to some implementations of the current subject matter;

FIG. 2 illustrates an exemplary process for generating a visual representation of an insurance policy, according to some implementations of the current subject matter;

FIGS. 3a-h illustrate various user interfaces associated with a visual representation of an insurance policy, according to some implementations of the current subject matter;

FIG. 4 illustrates an exemplary system, according to some implementations of the current subject matter; and

FIG. 5 illustrates an exemplary method, according to some implementations of the current subject matter.

### DETAILED DESCRIPTION

In some implementations, the current subject matter relates to visually representing insurance policy coverage, including providing graphical information representation of a policy designed to provide an insurance coverage for an object. The object can include at least one of the following: a real property, a personal property, a vehicle, jewelry, and/or any other object. The visual representation of the object can be based on at least one of the following: data describing the object, text, audio and/or video information associated with the object, written narrative information, information obtained from third party sources (e.g., the Internet, government databases, and/or any other sources) and/or any other information. The information can be obtained from one or more policyholders (i.e., an entity desiring to insure the object), third parties, etc. The information can be transmitted to the insurance carrier using wired, wireline, and/or wireless networks, local area networks (“LAN”), metropolitan area networks (“MAN”), wide area networks (“WAN”), the Internet, and/or any other networks. For illustrative, non-limiting purposes only, the following discussion is presented in connection with such visual representation of insurance policy for an object, where the object is a real property (e.g., a house, an industrial property, land, etc.). However, as can be understood, the current subject matter can be applicable to any other types of objects to be insured for any purpose.

In some implementations, as part of an insurance policy management process, the current subject matter can allow a customer or a user to view and make changes to an insurance policy using elements associated with a visual representation of the insurance policy. In some exemplary implementations, the insurance policy coverage information can be presented to the user as a visual representation of the insured items (e.g., property, vehicle or personal belonging) in the policy coverage. The current subject matter can enable creation (and/or generation) of the visual representation (e.g., info-graphic) of property attributes provided by a user (e.g., policyholder). The info-graphic can include a modular system that can allow dynamic elements that can generate many variations. The current subject matter can include a graphics engine that can assemble modules (e.g., different roof types, garage type, etc.) to create a visual representation of an insured property (e.g., a residential home). As such, the current subject matter can take the insurance policy obtaining process from a laundry-style text list to an interactive process.

In some implementations, the current subject system can display a graphical user interface that can enable the user to interact with the insurance policy management process through a visual representation of the insured items. The graphical user interface can include a frame containing the visual representation and a separate frame for one or more input controls associated with the insurance policy management process. For example, one of the input controls can relate to the household information of the policy such that the user can select to add and/or modify the existing household information. In another example, one of the input controls can relate to the option to switch between the visual representation and the text representation of the policy information.

In some implementations, the current subject matter can obtain user information relating to an insurance product offering (e.g., an insurance policy). The current subject matter can prompt a user to submit personal information including information relating to insurable items (e.g., property, vehicle, personal belongings, etc.). In turn, the current subject matter can render data that can represent the visual representation to be provided for display on a display screen of a client computing device associated with the user. The current subject matter can map aspects of a text representation of the insurance policy into corresponding aspects of the visual representation. Further, certain aspects of the text representation can be associated with one or more objects (e.g., graphical representation of the insured items) in the visual representation. The current subject matter can enable the user to interact with the visual representation by allowing the user to provide user input that corresponds to an action in the insurance policy management process. For example, the user can request to view additional information relating to a feature of a property (e.g., a fireplace, windows, roof, etc.) by selecting a corresponding element of the visual representation that represents that feature (e.g., a graphical object that represents the fireplace). In some exemplary implementation, the current subject matter can allow the user to toggle from the visual representation to the text representation of the insurance policy.

In some implementations, the current subject matter can provide several advantages over conventional policy management systems including at least one of the following: an enhanced interface including visual feedback to the user, a personalized experience for the user based on visual features of insured items, an increased engagement for the user by enabling access to restricted information (or additional information) relating to aspects of the insurance policy, enabling the user to make incremental refinements to the insurance policy, providing tailored information including content likely of interest to the user such as explanations and options relating to the policy coverage, and promoting an enhanced relationship between the user and the insurance provider.

As will be discussed below, the current subject matter can provide a rendering of a visual representation of policyholder information (e.g., insurance policy coverage) for display to a user. The current subject matter can be implemented on one or more computing devices (e.g., servers, workstations, databases, storage devices, etc.) in communication with a network. The current subject matter can be associated with an insurance platform provided by an insurance company and can include one or more servers, databases and/or other computing devices that can be affiliated with the insurance company and/or a third party that can be associated with the insurance company. Client computing devices, which the user can use to obtain insurance coverage, can be communicatively coupled to the insurance company's computing devices over a network.

In some implementations, client computing devices can include at least one of the following: a desktop workstation, a laptop, a mobile device, a smartphone, a tablet, a mobile telephone, a camera device, a usage-based insurance (“UBI”) enabled device, and/or any other client computing device. The client computing devices can be associated with a user and/or user (e.g., policyholder).

In some implementations, the user can initiate an application process to obtain an insurance policy by accessing a web portal associated with the insurance provider. The web portal can include one or more splash pages relating to the application process. An insurance quote process can be part of the application process, and thereby can be accessible through the splash pages. The web portal can be accessed through a web client such as a web-based application or a web browser. The web portal can be accessed over the network through a native application installed on the client computing device. The web portal can include one or more additional pages relating to the insurance quote process separate from the application process. In some exemplary implementations, the application process can be initiated by the user through a telephone system whereby an agent of the insurance provider (e.g., a live person) can establish communication with the user to complete the application process.

The application process can provide the insurance provider an opportunity to capture information relating to the user. The application process can include at least one of the following: a page relating to personal information about the user, a page relating to information about a property to be insured under the policy, a page relating to information about the household (e.g., primary policyholder, desired coverage amounts, etc.), a page relating to results associated with the insurance quote process, and a page relating to a payment step to complete the application process. In the page relating to the property, the user can be prompted to submit information relating to characteristics of the property (e.g., residential home, etc.). For example, the page can include text-based fields to enable the user to enter information including at least one of the following: year built, square footage, number of stories, number of separate living units, whether the home is within a certain range from a fire hydrant, purchase date, whether the user is the original owner, encumbrances (e.g., liens such as mortgages), and/or whether the user opts to use an escrow account associated with the mortgage to pay for the policy. In addition, the page can also include options relating to home safety features that represent discounts in premium rate for the policy (e.g., fire or burglary prevention devices, alarms, etc.).

In some implementations, the current subject matter can generate rendered data based on the user information uploaded through the application process portal. The uploaded data can include information relating to the insured item (e.g., property) and/or the household. For example, once the insurance policy is purchased by the user, the current subject matter can transform (and/or map) one or more aspects of the user information, received through the web portal, into corresponding graphical elements of the visual representation. The mapping can be performed using a number of defined variables, where each variable can include a number of options relating to the graphical elements. The current subject matter can use one or more algorithms related to image processing to determine the graphical elements that correspond to aspects of the policy information. In some implementations, the current subject matter can be communicatively coupled to third party systems to obtain technical data relating to the insured item (e.g., specifications, floorplans, permits, etc.) to generate more accurate rendered data of the insured object. The graphical elements can be images, photographs, videos, etc. representing the insured object and any associated items. Alternatively and/or in addition to, the current subject matter can obtain image information from the user. The user and/or an appraiser associated with the insurance provider can upload an image, a photograph, a video, etc. to be used as one of the graphical elements for generating the visual representation and/or profile information associated with the policy information such that the visual representation closely resembles the insured items. In some implementations, the current subject matter can obtain location information (and/or mapping information) from a third party map service to modify the visual representation with additional context (e.g., certain landscape backgrounds, etc.) based on the geo-location information.

In some implementations, the user (and/or policyholder) can be requested to submit login credentials for an account (e.g., policy information) associated with the user as part of the insurance policy management process. The account can be viewed and/or accessed through the web portal on the network using the web browser or the application. The current subject matter can generate a prompt to be displayed on a display screen of the client computing device. The prompt can include fields to enter an e-mail address (and/or username) including a password for the account. The prompt can be part of a splash page provided for display on the web portal depending on implementation. The splash page can include information relating to legal disclaimers and/or additional information relating to the insurance provider. Upon login, the user's insurance policy information can be displayed. The rendered data can be obtained from a repository (e.g., local storage or cloud storage) for display and/or the rendering can be initiated on-the-fly in response to a successful login to the account.

In some implementations, the current subject matter can transmit the rendered data to a client computing device associated with the user to verify the rendered data. The user can be requested to confirm the accuracy of uploaded data (e.g., application process information) and/or downloaded data (e.g., stored policy information). The user can also add/change the data either voluntarily and/or upon receiving an appropriate request.

In some implementations, a notification can be transmitted to the client computing device that can include an indication that the rendered data is complete and/or available for viewing. As a result of the notification, a prompt can be displayed to enable the user to select to view the visual representation of the policy information. The notification can include a prompt to save the visual representation of the policy information in a memory of the client computing device and/or other memory communicatively coupled to the client computing device (e.g., cloud storage, flash drive). The notification can cause a prompt to be displayed to enable the user to share the visual representation of the policy information with other users associated with the user over a network (e.g., a social network).

In some implementations, the visual representation can be generated by at least one server communicatively coupled to the client computing device. In this respect, the client computing device can upload the personal information to the server such that the server can generate the rendered data using one or more graphics engines associated with the server. In turn, the server can transmit the rendered data to the client computing device. The client computing device can receive an indication that the completed visual representation is available for viewing by the user. The indication can include a secured link to enable the user to access the completed visual representation over the network. The completed visual representation can be transmitted to the client computing device in real-time as part of an open session associated with the insurance policy management process. The visual representation can be generated at the client computing device using a local graphics engine associated with the web client. The graphics engine can use one or more computer generation algorithms that generate objects and/or retrieve a library of objects to be included in the visual representation.

The visual representation of the insured object and/or associated items included in the policy information can be displayed in a two-dimensional format and/or a three-dimensional format and/or in any other desired format. For example, the visual representation in the three-dimensional format can provide the user with a full view of the insured object (e.g., residential home). In some implementations, the user can select different views of object based on the visual representation including varying the number of elements used to create the visual representation. For example, the visual representation can show a residential home with an item representing the garage in a first view, and/or provide the residential home without the garage in an alternative view. In some implementations, the visual representation can include elements that provide contextual information with respect to the insured item (e.g., landscape such as shrubs and/or trees around the residential home).

In some implementations, the user can be provided with options relating to various elements used to generate the visual representation. For example, each of the options can correspond to a different type of roof structure for the residential home (e.g., shed, gable, mansard, gambrel, combination, hip, butterfly or flat roof). Similarly, each of the options can correspond to a different vehicle type (e.g., sedan, coupe, truck, sport utility) in vehicle related policy information. In some implementations, the current subject matter can include a control interface with options to select a particular roof type, a particular garage size and a particular color from a color palette matrix. The control interface can be displayed simultaneously with the visual representation, and changes with respect to the control interface can be reflected in real-time on the visual representation. In some implementations, an insurance policy can be added to an existing policy information and/or a new quote for a new policy can be requested.

In some implementations, the residential home can be displayed with one or more labeled elements that identify corresponding characteristics of the residential home. The visual representation can include a labeled element for a foundation of the home, a fireplace, a roof, a garage, etc. and the exterior of the home. The current subject matter can trigger an additional window (and/or overlay) to be displayed upon detection of a user input at or near the labeled element. The additional window can include additional information describing an applicable coverage for the corresponding characteristic. For example, the window can display whether the user has coverage for fireplaces and wood burning stoves or only wood burning stoves, etc.

In some implementations, the current subject matter can enable the user to create an inventory of household items. The user can use the inventory for claim settlement such that the user does not have to provide receipts after the fact. For example, the user can select from a list of items that may have been damaged. For example, the user can attach (and/or upload) documentation relating to an insurance claim by receiving selection of one of the labeled elements associated with an insured item. In particular, the user can select a television insured under the policy to attach (and/or upload) a receipt of purchase for the television. In this example, the television can be part of an active (and/or existing) insurance claim accessible through the policy information.

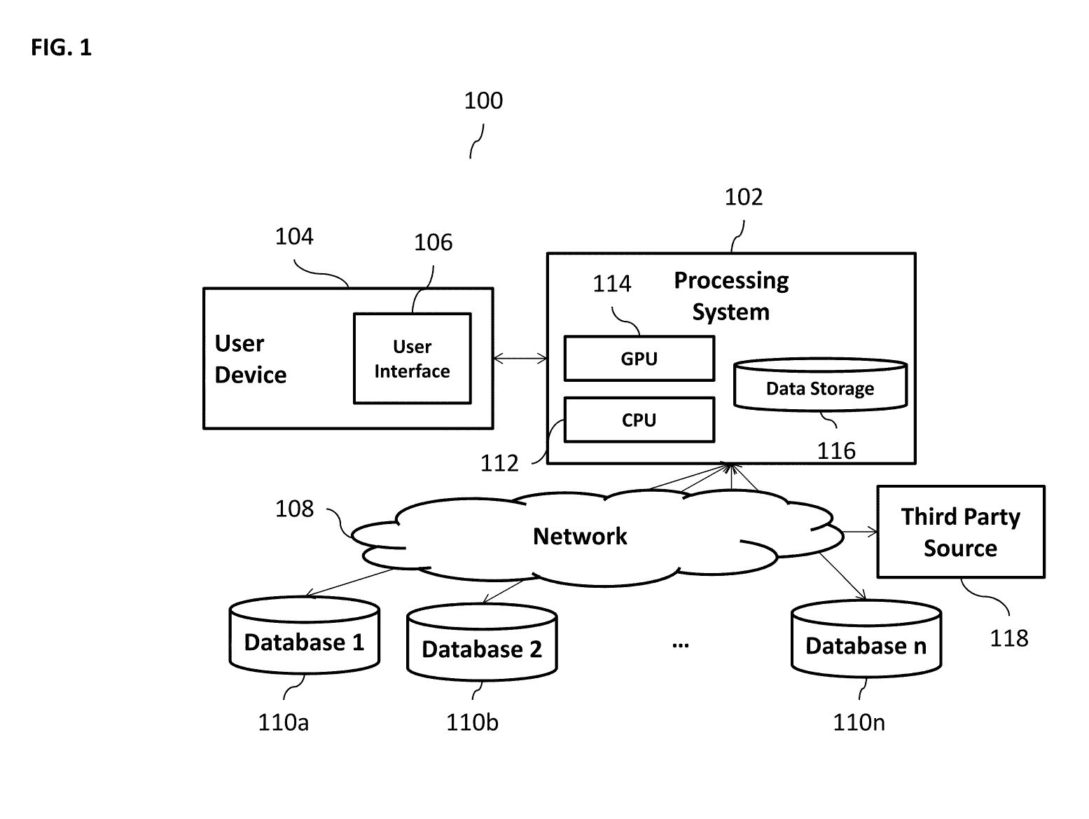

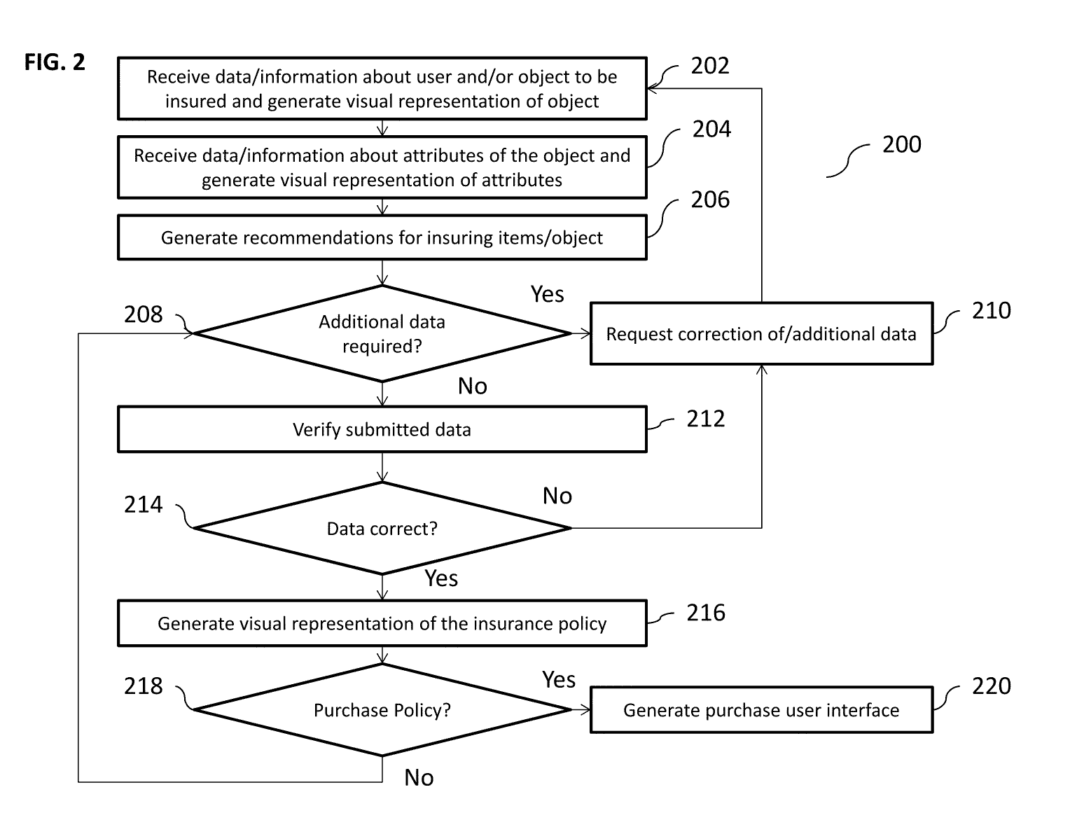

FIG. 1 illustrates an exemplary system 100 for visualizing an insurance policy for insuring an object (e.g., a property, a vehicle, a tangible item, a non-tangible item, etc.), according to some implementations of the current subject matter. The system 100 can include a processing system 102, a user device 104 (e.g., for use by a policyholder (or prospective policyholder), a user associated with the policyholder, an insurance agent, and/or any other user)), and a plurality of databases 110a, 110b, . . . 110n. The processing system 102 can include one or more servers that can have one or more processors 112, one or more graphics processors 114, one or more data storage components 116, communication capabilities (e.g., wired, wireline, and/or wireless), as well as any other components, and/or any combination thereof. The processing system 102 can be communicatively coupled to the user device 104. The processing system 102 and the device 104 can be communicatively coupled using a wired, wireline, and/or wireless network, which can include at least one of the following: a virtual network, Internet, intranet, extranet, MAN, WAN, LAN, and/or any combination thereof.

The device 104 can include at least one of the following: a mobile telephone, a mobile device, a smartphone, a tablet, a desktop computer, a laptop, a personal digital assistant (“PDA”), a scanner, a monitor, and/or any other device and/or any combination thereof. The device 104 can be any combination of software and/or hardware and can include one or more software applications being executed on the device 104 that can allow communication and processing of the data exchanged between the device 104, the processing system 102, and the databases 110.

The processing system 102 can be communicatively coupled with one or more databases 110 via one or more communication networks 108. The network 108 can be a wired, wireline, and/or wireless network, which can include at least one of the following: a virtual network, Internet, intranet, extranet, MAN, WAN, LAN, and/or any combination thereof. The databases 110 can be used to gather various data related to the event for processing and recreation by the processing system 102. The databases 110 can store at least one of the following: an audio data, a video data, a photographic data, global positioning system coordinates, data related to the user, data related to the object and/or any items associated with the object, textual data (e.g., written narrative information, a witness statement, etc.), data/information obtained from third party sources 118 (e.g., news sources, government agencies, etc.) and/or any other data/information, and/or any information thereof. The data/information stored in the databases 110 can be obtained automatically, entered manually, obtained as a result of a trigger associated with the a predetermined event (e.g., a user desiring to obtain an insurance policy quote for a property, a user desiring to update the insurance policy quote based on the updated information, etc.).

In some implementations, the processing system 102, using one or more of its processors 112, 114, can receive the data from the databases 110 and/or the user device 104 for processing. The processors 112, 114 can analyze received data and generate one or more user interfaces (e.g., windows, splash pages, pop-ups, etc.), which can be displayed on one or more user interface components 106 of the device 104 and/or any other devices that may be communicatively coupled to the processing system 102. The user interfaces can be transmitted over communication networks connecting the device 104 to the processing system 102. The user interfaces can be presented to the user and can display data for informational purposes, request user to enter information, request user to acknowledge correctness of information, and/or for any other purposes.

To generate a user interface based on the received information, the processing system 102 can recognize the information and/or data that are being received from the user (through entry on the user device 104) and/or databases 110 and/or any other third party sources. The processing system 102 can recognize information/data (e.g., data packets) based on the data identifiers contained in the transmitted information/data. In some exemplary implementations, the processing system 102 can perform a shallow packet inspection and a deep packet inspection of data packets that it receives to extract various information, which can be used to determine the origin of the information/data, its content, and/or any other information that the processing system 102 can use for any further processing. Based on the extracted information/data, the processing system 102 can determine how to assemble the information and/or create a user interface for transmission to the device 104.

The processing system 102 can further determine that in order to generate a user interface (e.g., a user interface containing an insurance policy quote for insuring a property), it needs additional information. To obtain such additional information, the processing system 102 can forward a request (e.g., a hypertext transfer protocol (“HTTP”) request, etc.) to the user device 104, the databases 110, and/or any other third party sources, to provide such information. The processing system 102 can also determine which of the device 104, the databases 110, and/or any other third party sources 118 can possess the additional information and, upon such determination, the processing system 102 can appropriately format its request for additional information and forward same to the determined/selected source. Alternatively, the processing system 102 can broadcast its request for additional information to all available sources of information.

Once the information/data and/or any additional information/data are received, the processing system 102 can combine the information/data into the user interface for display on the user device 104. The processing system 102 can use one or more templates to compile information together and organize it into a particular user interface. The templates can be specific to a particular object that is being insured, for which the processing system 102 can generate a user interface, and can include a plurality of data fields that can be populated with the received information/data. For example, if the object is a real property, the processing system 102 can select a real property template, which can include at least one of the following data fields: owner information (e.g., name, age, income, occupation, smoker/non-smoker, etc.), occupant information (e.g., name, age, income, occupation, smoker/non-smoker, etc.), mortgage information, property information (e.g., address, square footage of land and/or structure(s), number of floors, number of rooms, number of bedrooms, number of bathrooms, existence of a garage and its size, existence of a pool, etc.), specific information related to the property (e.g., type of property, number of structures on the property, type of construction materials used, year built, utilities used, etc.), specifics related to items associated with the property (e.g., presence of a fireplace, location of a nearest fire hydrant, existence of personal items that are to be covered under the policy), whether the policy will be associated and/or combined with any other insurance policies, etc., and/or any combination thereof. If the object relates to a vehicle, the processing system 102 can select a vehicle template, which can include at least one of the following data fields: vehicle identification number, make and/or model of the vehicle, year manufactured, date sold, accident reports, liability protection desired, etc., and/or any combination thereof. In some implementations, the processing system 102 can create templates for different types of objects that the user wishes to insure (e.g., jewelry, paintings, personal items, etc.) to accommodate generation of user interfaces containing visual representations of policies. In some implementations, the processing system 102 can generate user interfaces without use of templates and provide such user interfaces to the devices 104 in free form.

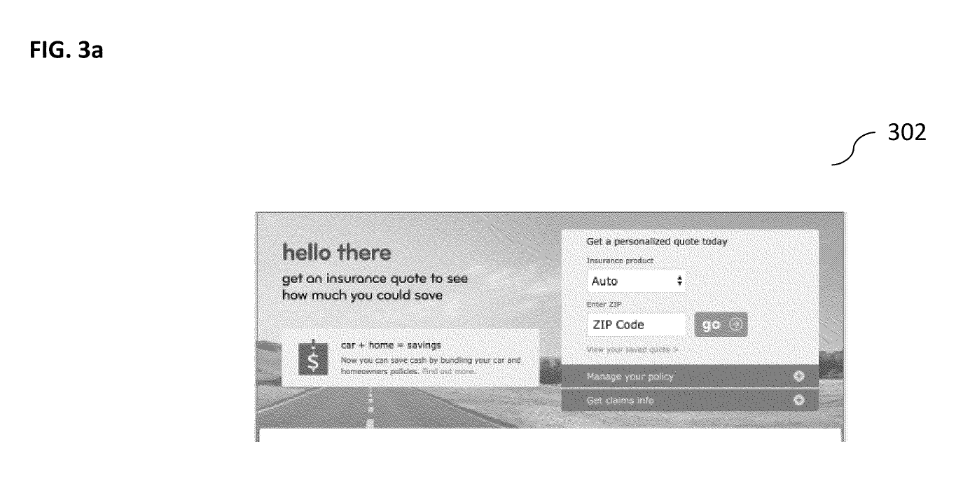

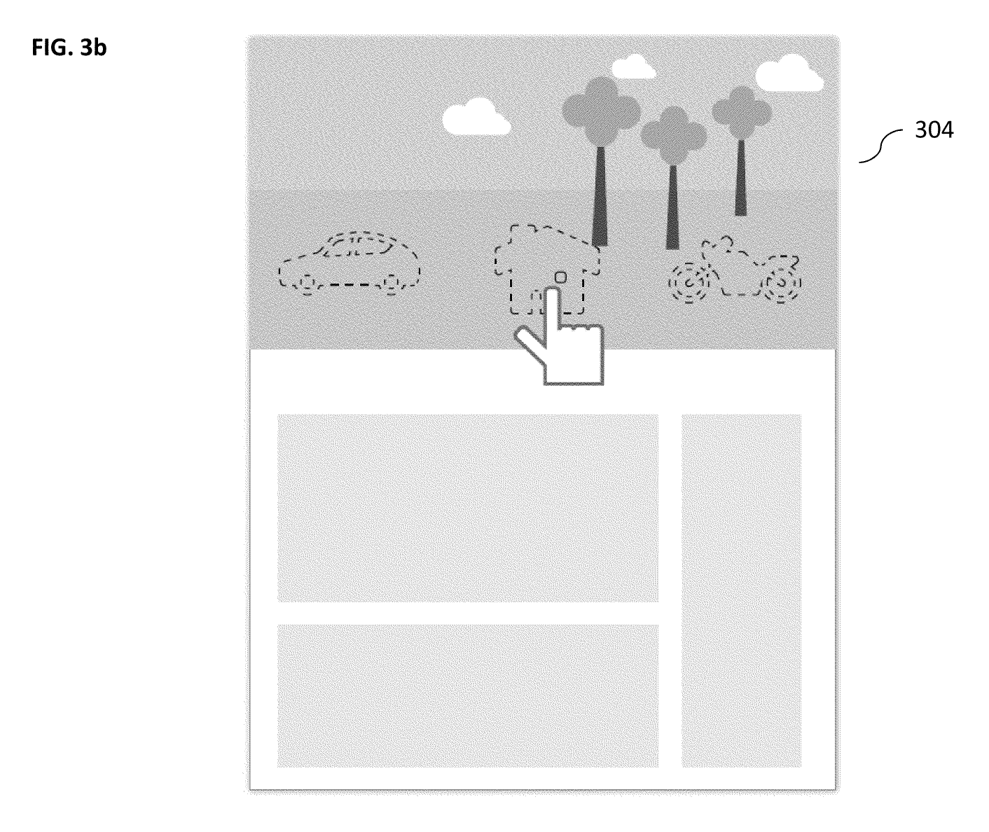

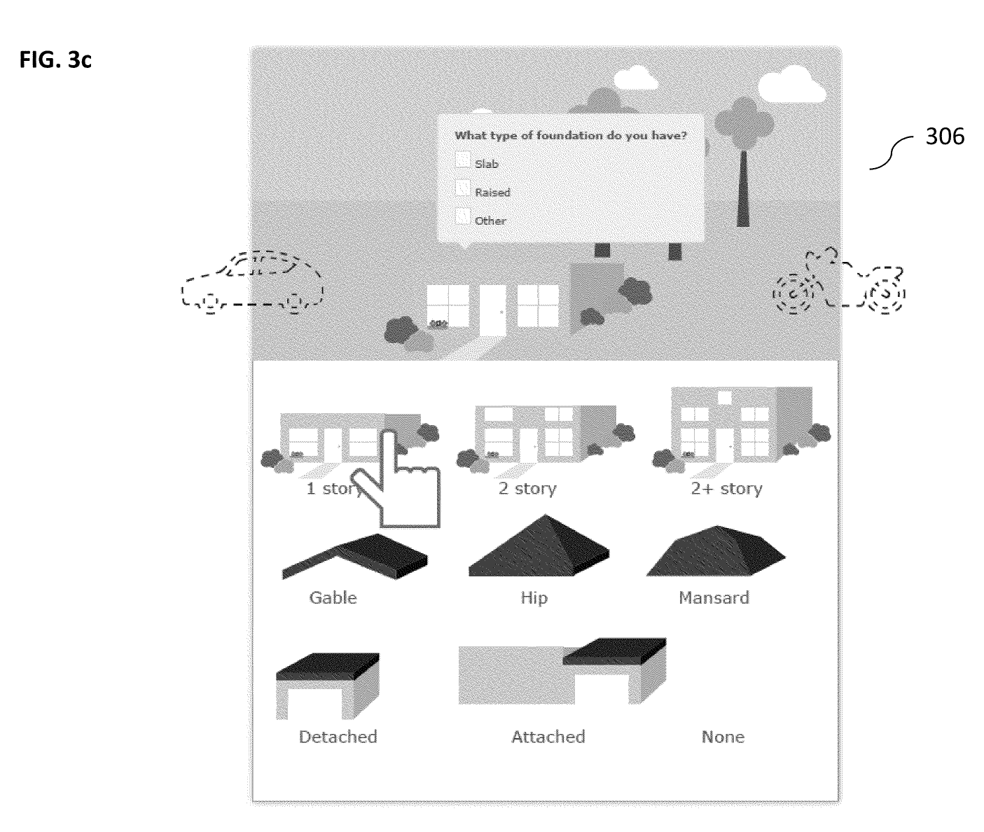

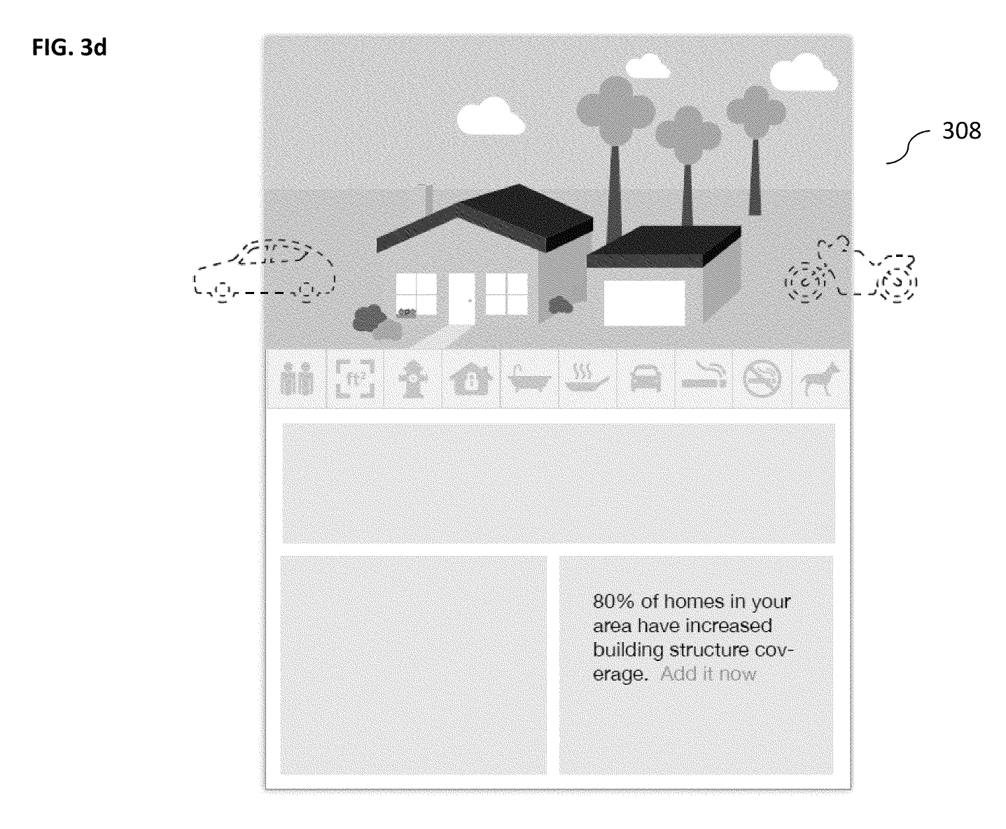

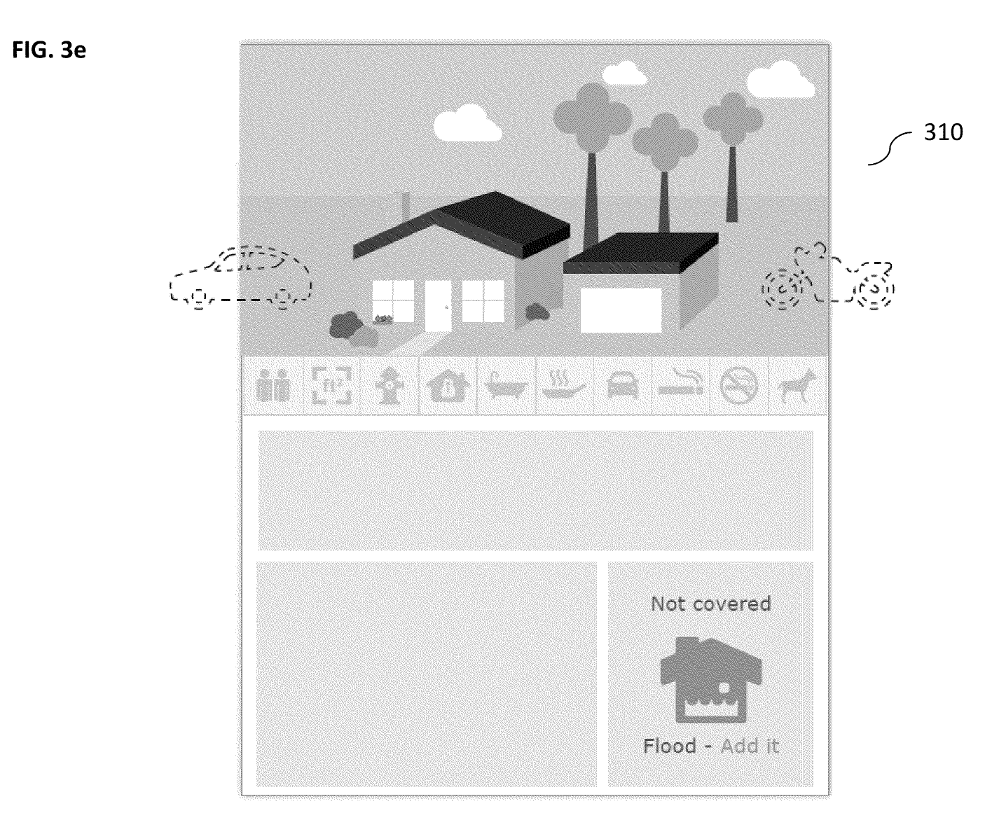

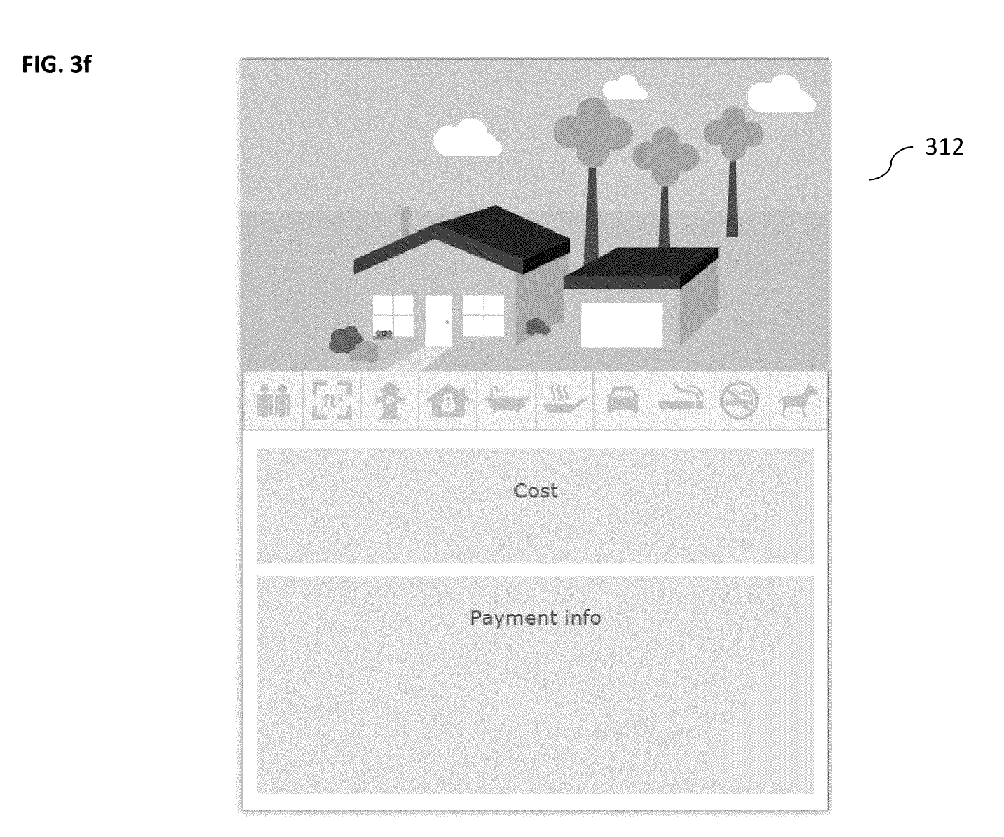

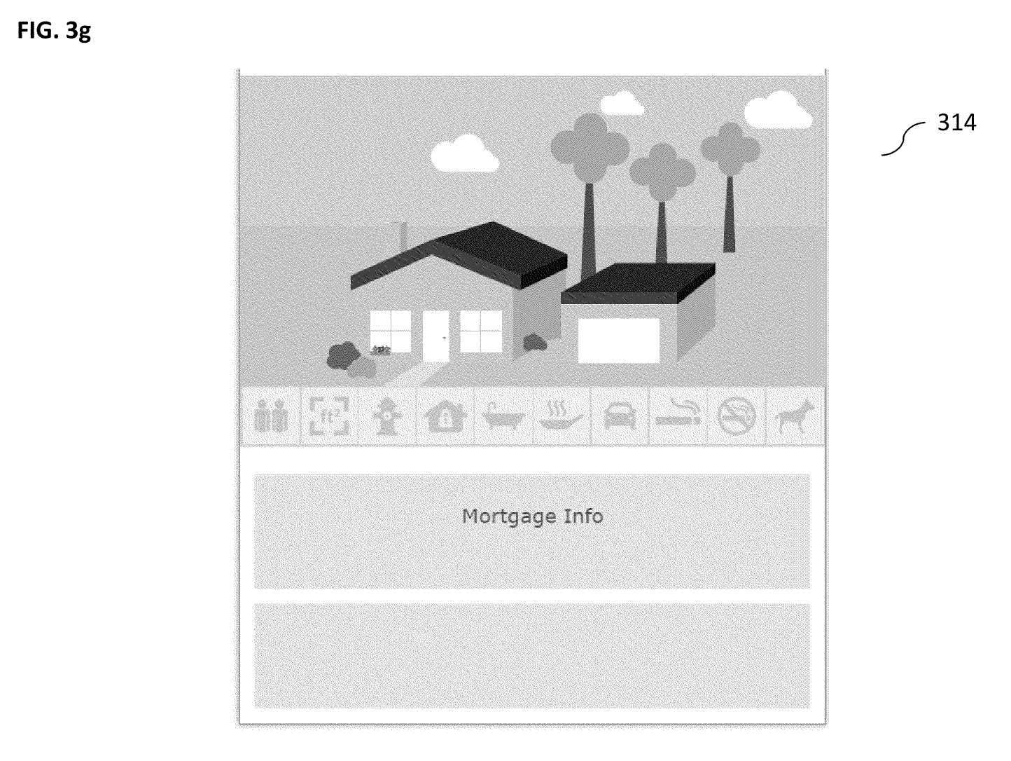

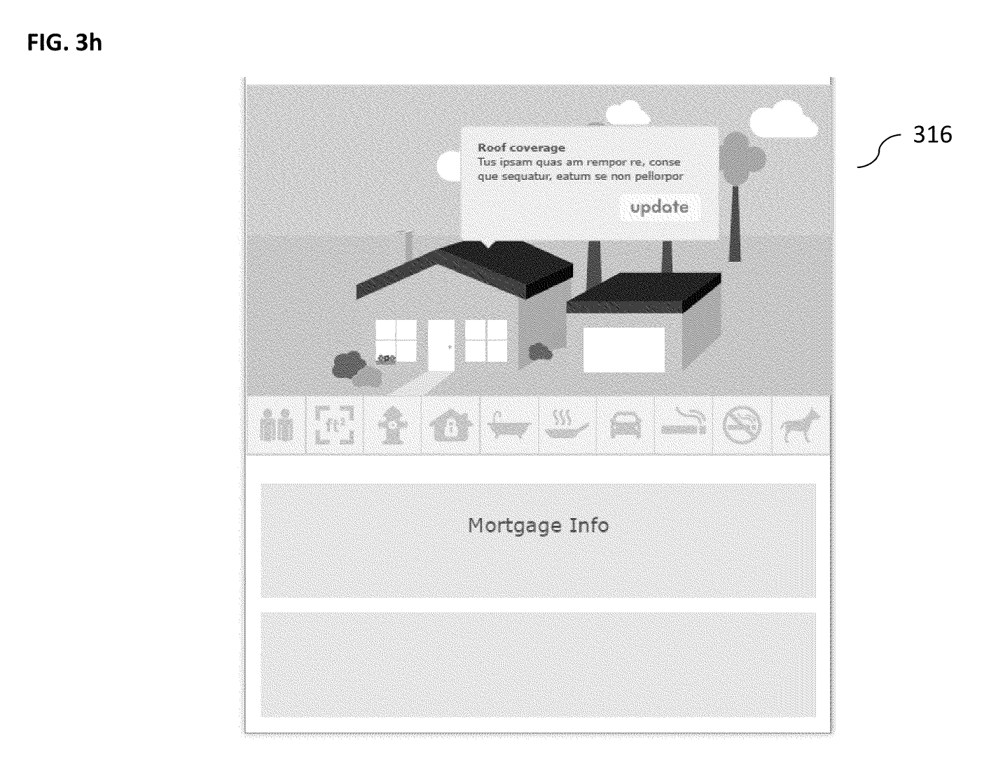

In some implementations, the databases 110 can store information/data relating to and depending on a type of the object. The information/data stored can include graphics objects relating to various categories of items associated with the object to be insured. For example, if the object is a real property, the databases 110 can store graphical objects showing a general layout of a property (in some implementations, the user can provide a picture of the property, which can be used instead of a “file photo” picture), layouts of the property that depend on a number of floors, types of roofs that may be associated with the property, etc. (as shown in FIG. 3c). The processing system 102, upon user selecting a particular option on the user device 104, can access one or more databases 110 and obtain a requisite graphical object for displaying on the user interface 106. Once the object is selected, the processing system 102 can generate a user interface that displays what the user has selected (as shown in FIG. 3d). The processing system 102 can continue to generate requests to the databases 110 for graphical objects and/or any other information/data during the insurance quote generation process.

Once the requisite information has been obtained, the processing system 102 can generate a visual representation of the insurance policy for the object and store the representation in one or more databases 110 and/or its data storage component 116 as well as display it using user interface component 106 on the user device 104. The user using device 104, which can include a software application (e.g., a mobile application that can be downloaded to the device 104) capable of generating one or more user interfaces for display using user interface component 106, can submit data relating to the property and/or any items related to the property that should be considered in determination of an insurance policy quote and generation of a visual representation of the policy. In order to submit information, the user can be prompted to enter login credentials to access the software application, submit information/data, and/or view any user interfaces that may be generated and forwarded to the device 104 by the processing system 102. In the exemplary implementation of an insurance claim relating to a real property, the user can also use the software application to edit the information contained in various user interfaces (as shown and discussed in connection with FIGS. 3a-3h) generated by the processing system 102 and/or verify that the information contained in the generated user interfaces is accurate. In some implementations, the processing system 102 can also perform its own verification of information submitted using the user device 104. This can be accomplished by accessing third party sources 118 and verifying the information. The third party sources 118 can be government databases, private databases, news sources, social networks, etc.

FIG. 2 illustrates an exemplary process 200 for generating a visual representation of an insurance policy, according to some implementations of the current subject matter. The process 200 can be performed by system 100 shown in FIG. 1 and/or any variation thereof. At 202 and 204, the processing system 102 can receive data/information about the user and/or object to be insured and/or the attributes of the object and generate a visual representation of the object/attributes. The processing system 102 can receive the information/data from the user, who is using device 104. The user, using device 104, can access a web portal (e.g., web portal 302 as shown in FIG. 3a) of an insurance company (e.g., by generating a hypertext transfer protocol (“HTTP”) request) for the purposes of creating an insurance quote. In some exemplary implementations, the user can be prompted to create an account with the insurance company and/or create a user login and/or password. The account login/password can provide security to the user's information.

Alternatively, the user can access a web portal of an insurance company for the purposes of generating a visual representation of a policy without creating an account and/or a user login/password. In this scenario, the insurance company may choose to limit user's functionalities to prevent access to secure information.

Upon receiving user's request (or a trigger) for a visual representation of a policy, the processing system 102 can generate a user interface that can include a prompt to the user requesting the user to identify the type of object that the user wishes to insure. The user interface (e.g., user interface 304 as shown in FIG. 3b) can be displayed on the user device 104 using user interface component 106. The user interface can display various object options that can be available to the user, e.g., a vehicle, a property, a motorcycle, a personal property, jewelry, painting, etc. The object options can be presented to the user in the form of graphical objects, icons, pop-ups, prompts, drop-down menus, etc. The user can then select an object for which a policy quote through a visual representation of the policy is desired. The selection can be accomplished through clicking on the graphical object corresponding to the desired object (e.g., property), typing in the type of object (e.g., “Property”), etc. The user can use a keyboard, a mouse, a touchscreen, etc., that can be associated with the user device 104 for performing selection of objects.

In some implementations, the user can also enter information about the user and the object being insured. As stated above, some exemplary information can include at least one of the following owner information (e.g., name, age, income, occupation, smoker/non-smoker, etc.), occupant information (e.g., name, age, income, occupation, smoker/non-smoker, etc.), mortgage information, property information (e.g., address, square footage of land and/or structure(s), number of floors, number of rooms, number of bedrooms, number of bathrooms, existence of a garage and its size, existence of a pool, etc.), specific information related to the property (e.g., type of property, number of structures on the property, type of construction materials used, year built, utilities used, etc.), etc. Additional user interfaces (e.g., user interface 306 as shown in FIG. 3c) can be generated by the processing system 102 and transmitted to the user device 104 seeking information from the user. For example, as shown in FIG. 3c, the user can provide (e.g., by clicking, entering text, etc.) information about various attributes of the object, e.g., a number of floors associated with the real property for which an insurance quote is being sought, a type of roof, whether a garage exists on the property, a type of foundation, whether trees exist on the property, etc.

The entered information/data can be transmitted to the processing system 102 via a communications network. Based on the received information, the processing system 102 can generate an appropriate graphical representation of the object and/or any attributes of the object that have been selected/provided by the user. The graphical representation can be transmitted to the user device 104 for displaying using user interface component 106 (e.g., user interface 308 as shown in FIG. 3d).

At 206, the processing system 102 can also generate option(s) for insuring object and/or items. For example, based on the information/data provided by the user, the processing system 102 can offer to the user the option to obtain an increased coverage for the property and provide a link to add coverage (e.g., “80% of homes in your area have increased building structure coverage” as shown in FIG. 3d). Alternatively, the processing system 102 can determine that the property is not insured against a particular type of damage and offer to the user to obtain that coverage (e.g., “Not covered for Flood” as shown in the user interface 310 shown in FIG. 3e).

At 208, the processing system 102, based on the information provided by the user can request the user to determine whether the entered information is correct. If the user indicates that the information is not correct, the processing can proceed to 210, where user can be requested to provide corrections and/or additional information, subsequent to which the processing returns to 202 to generate an update visual representation of the object for which an insurance quote is being sought. The request to provide corrections and/or updated and/or additional information can be accomplished through use of icons, prompts, pop-ups, drop-down menus, text entries, etc. (as shown in FIGS. 3d-3e). In some exemplary implementations, the corrections/updates/additions can relate to at least one of the following: a number occupants of the property, square footage of the property, nearest fire hydrant location, existence of a security system on the property, a number of baths (full and/or half), a number of kitchens, a number of cars associated with the property, whether occupants are smokers/non-smokers, presence of pets on the property, etc. and/or any other type of attributes, and/or any combinations thereof.

If the entered information is correct and no further changes, additions, etc. are required, the processing system 102 can perform verification of the submitted data, at 212. In some implementations, verification can be performed by the processing system 102 accessing internal and/or external sources and comparing information existing at those sources. The sources can include databases 110 and/or third party sources 118. For example, the processing system 102 may wish to verify mortgage information associated with the property and determine whether there are special requirements of the mortgage company that may affect an eventual insurance policy that may be generated. The processing system 102 can also access municipal database to verify square footage information, construction material, age of the property, etc. Further, the processing system 102 can also access databases 110 to determine whether information about the property has been previously stored and how, if such, that information may have changed and/or is incorrect.

If after performing verification, at 212, the processing system 102 determines that one more information/data is incorrect, the processing can return to 210, where a request for correction of and/or additional information/data can be presented to the user via a user interface displayed using user interface component 106. The process 200 can then proceed as discussed above and, if necessary, an update graphical representation of the property can be generated.

If the entered information/data is correct, the processing system 102 can generate a visual representation of the insurance policy and present it to the user via a user interface that can be displayed on the user device 104, at 216 (e.g., user interface 312, as shown in FIG. 3f). The visual representation of the policy can include a graphical representation of the object (e.g., property) having information/data relating to all attributes (e.g., one story dwelling, gable roof, detached one car garage, fireplace, etc.) entered by the user and/or obtained by the processing system 102. The user interface 312, as shown in FIG. 3f, can include an information about the cost of the policy, as well as a breakdown of how the cost was determined. The displayed user interface 312 can also generate a prompt to the user asking the user whether the user wishes to purchase the generated policy and provide an ability to enter payment information.

If the user decides to purchase the policy, the user can enter payment information directly on the user interface 312, at 220. If the user is not ready to purchase the policy and/or wishes to make changes and/or determine what the policy cost would be if certain changes are applied, the processing can return to 208. The changes can include entry of updated mortgage information (e.g., via user interface 314, as shown in FIG. 3g), change, whether actual or hypothetical, in attributes associated with the property (e.g., replacement of a roof, as indicated in FIG. 3h via user interface 316), etc.

Once all changes are completed and the user has determined that the policy can be purchased, the user can enter payment information using user interface component 106 and the user device 104 can transmit it to the processing system 102. The processing system 102 can verify and/or process payment information. Once the payment information has been processed/verified, the processing system 102 can generate policy documents and transmit same to the user device 104. The processing system 102 can also store the information obtained during the process 200 as well as the eventual policy documents that have been generated. The obtained information can be used for future claim processing purposes, determination of user account status, providing discounts, policy changes, cost increases, etc.

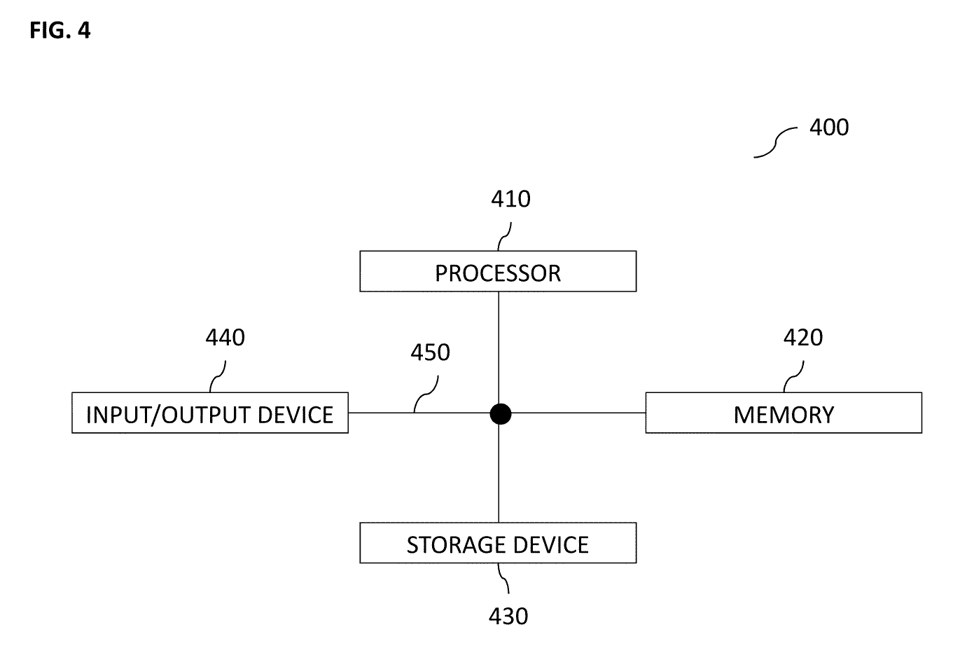

In some implementations, the current subject matter can be configured to be implemented in a system 400, as shown in FIG. 4. The system 400 can include a processor 410, a memory 420, a storage device 430, and an input/output device 440. Each of the components 410, 420, 430 and 440 can be interconnected using a system bus 450. The processor 410 can be configured to process instructions for execution within the system 400. In some implementations, the processor 410 can be a single-threaded processor. In alternate implementations, the processor 410 can be a multi-threaded processor. The processor 410 can be further configured to process instructions stored in the memory 420 or on the storage device 430, including receiving or sending information through the input/output device 440. The memory 420 can store information within the system 400. In some implementations, the memory 420 can be a computer-readable medium. In alternate implementations, the memory 420 can be a volatile memory unit. In yet some implementations, the memory 420 can be a non-volatile memory unit. The storage device 430 can be capable of providing mass storage for the system 400. In some implementations, the storage device 430 can be a computer-readable medium. In alternate implementations, the storage device 430 can be a floppy disk device, a hard disk device, an optical disk device, a tape device, non-volatile solid state memory, or any other type of storage device. The input/output device 440 can be configured to provide input/output operations for the system 400. In some implementations, the input/output device 440 can include a keyboard and/or pointing device. In alternate implementations, the input/output device 440 can include a display unit for displaying graphical user interfaces.

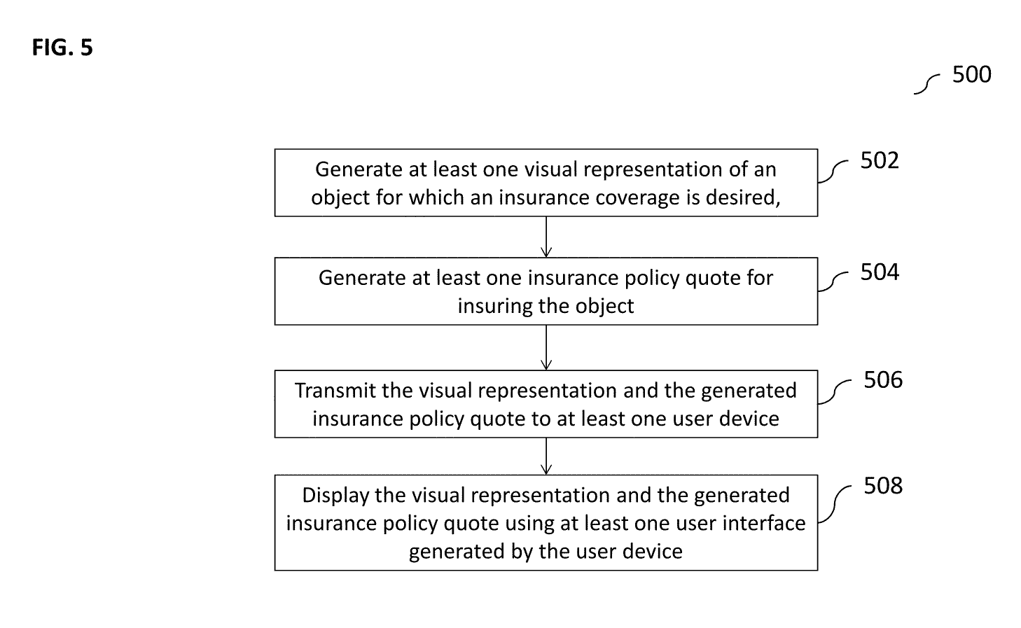

FIG. 5 illustrates an exemplary method 500, according to some implementations of the current subject matter. The method 500 can be performed by the system 100, as shown in FIG. 1. At 502, the system 102 (as shown in FIG. 1) can generate at least one visual representation of an object (e.g., a property) for which an insurance coverage is desired. In some implementations, the insurance coverage can be for an existing object (e.g., property, vehicle, etc.), where a user can see what the coverages are and what has been covered. Alternatively, the insurance coverage can be for an entirely new object, i.e., one that has not yet been insured by the insurance company. The visual representation can be generated based on a data, received over a communications network, describing the object. The data can be provided by the user using a user device 104 and/or obtained by the processing system 102 from one or more databases 110 and/or a third party source 118. The data can contain a plurality of attributes (e.g., data identifying that the property includes a fire place, a garage, a slanted roof, etc.) associated with the object. The visual representation can graphically represent the object and at least one attribute in the plurality of attributes. At 504, the system 102 can generate at least one insurance policy quote for insuring the object. At 506, the system can transmit the visual representation and the generated at insurance policy quote to at least one user device, i.e., user device 104. The user device 104 can be any type of computing device, e.g., a desktop computer, a laptop, a smartphone, a tablet, a telephone, a mobile device, etc. At 508, the visual representation and the generated insurance policy quote can be caused to be displayed using at least one user interface generated by the user device.

In some implementations, the current subject matter can include one or more of the following optional features. The method 500 can further include verifying the data describing the object. The object can includes at least one of the following: a tangible object, an intangible object, a real property, a personal property, a vehicle, a motorcycle, a residential property, an industrial property, a jewelry, a painting, and any combination thereof. The data describing the object can include at least one of the following: a video data, an audio data, a text data, a photographic data, and any combination thereof.

In some implementations, the method 500 can also include receiving changes to the data describing the object, generating, based on the received changes, a new visual representation and a new insurance policy quote, and transmitting the new visual representation and the new insurance policy quote to the user device.

In some implementations, the user interface can include at least one of the following: a data describing the object, a data describing at least attribute in the plurality of attributes, a graphical representation of the object, a graphical representation of at least one attribute in the plurality of attributes, a video illustrating the object and/or at least one attribute in the plurality of attributes, a narrative textual data describing the object, and any combination thereof.

In some implementations, the transmission of the visual representation can include transmitting at least one option for obtaining additional insurance coverage for the object.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

The systems and methods disclosed herein can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

As used herein, the term “user” can refer to any entity including a person or a computer.

Although ordinal numbers such as first, second, and the like can, in some situations, relate to an order; as used in this document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including, but not limited to, acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, LAN, WAN, and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

What is claimed:

1. A computer-implemented method, comprising:
generating at least one visual representation of an object for which an insurance coverage is desired, wherein the at least one visual representation is generated based on a data, received over a communications network, describing the object, the data containing a plurality of attributes associated with the object, the visual representation graphically representing the object and at least one attribute in the plurality of attributes;
generating at least one insurance policy quote for insuring the object;
transmitting the at least one visual representation and the generated at least one insurance policy quote to at least one user device; and
displaying the at least one visual representation and the generated at least one insurance policy quote using at least one user interface generated by the at least one user device;
wherein at least one of the generating the at least one visual representation, the generating the at least one insurance policy quote, the transmitting, and the displaying is performed by at least one processor of at least one computing system.

2. The method according to claim 1, further comprising verifying the data describing the object.

3. The method according to claim 1, wherein the object includes at least one of the following: a tangible object, an intangible object, a real property, a personal property, a vehicle, a motorcycle, a residential property, an industrial property, a jewelry, a painting, and any combination thereof.

4. The method according to claim 1, wherein the data describing the object includes at least one of the following: a video data, an audio data, a text data, a photographic data, and any combination thereof.

5. The method according to claim 1, further comprising
receiving changes to the data describing the object;
generating, based on the received changes, a new at least one visual representation and a new at least one insurance policy quote; and
transmitting the new at least one visual representation and the new at least one insurance policy quote to the user device.

6. The method according to claim 1, wherein the user interface includes at least one of the following: a data describing the object, a data describing at least attribute in the plurality of attributes, a graphical representation of the object, a graphical representation of at least one attribute in the plurality of attributes, a video illustrating the object and/or at least one attribute in the plurality of attributes, a narrative textual data describing the object, and any combination thereof.

7. The method according to claim 1, wherein the transmitting of at least one visual representation includes transmitting at least one option for obtaining additional insurance coverage for the object.

8. A system comprising:
at least one programmable processor; and
a machine-readable medium storing instructions that, when executed by the at least one programmable processor, cause the at least one programmable processor to perform operations comprising:
generating at least one visual representation of an object for which an insurance coverage is desired, wherein the at least one visual representation is generated based on a data, received over a communications network, describing the object, the data containing a plurality of attributes associated with the object, the visual representation graphically representing the object and at least one attribute in the plurality of attributes;
generating at least one insurance policy quote for insuring the object;
transmitting the at least one visual representation and the generated at least one insurance policy quote to at least one user device; and
displaying the at least one visual representation and the generated at least one insurance policy quote using at least one user interface generated by the at least one user device.

9. The system according to claim 8, wherein the operations further comprise verifying the data describing the object.

10. The system according to claim 8, wherein the object includes at least one of the following: a tangible object, an intangible object, a real property, a personal property, a vehicle, a motorcycle, a residential property, an industrial property, a jewelry, a painting, and any combination thereof.

11. The system according to claim 8, wherein the data describing the object includes at least one of the following: a video data, an audio data, a text data, a photographic data, and any combination thereof.

12. The system according to claim 8, wherein the operations further comprise
receiving changes to the data describing the object;
generating, based on the received changes, a new at least one visual representation and a new at least one insurance policy quote; and
transmitting the new at least one visual representation and the new at least one insurance policy quote to the user device.

13. The system according to claim 8, wherein the user interface includes at least one of the following: a data describing the object, a data describing at least attribute in the plurality of attributes, a graphical representation of the object, a graphical representation of at least one attribute in the plurality of attributes, a video illustrating the object and/or at least one attribute in the plurality of attributes, a narrative textual data describing the object, and any combination thereof.

14. The system according to claim 8, wherein the transmitting of at least one visual representation includes transmitting at least one option for obtaining additional insurance coverage for the object.

15. A computer program product comprising a non-transitory machine-readable medium storing instructions that, when executed by at least one programmable processor, cause the at least one programmable processor to perform operations comprising:
generating at least one visual representation of an object for which an insurance coverage is desired, wherein the at least one visual representation is generated based on a data, received over a communications network, describing the object, the data containing a plurality of attributes associated with the object, the visual representation graphically representing the object and at least one attribute in the plurality of attributes;
generating at least one insurance policy quote for insuring the object;
transmitting the at least one visual representation and the generated at least one insurance policy quote to at least one user device; and
displaying the at least one visual representation and the generated at least one insurance policy quote using at least one user interface generated by the at least one user device.

16. The computer program product according to claim 15, wherein the operations further comprise verifying the data describing the object.

17. The computer program product according to claim 15, wherein the object includes at least one of the following: a tangible object, an intangible object, a real property, a personal property, a vehicle, a motorcycle, a residential property, an industrial property, a jewelry, a painting, and any combination thereof.

18. The computer program product according to claim 15, wherein the data describing the object includes at least one of the following: a video data, an audio data, a text data, a photographic data, and any combination thereof.

19. The computer program product according to claim 15, wherein the operations further comprise
receiving changes to the data describing the object;
generating, based on the received changes, a new at least one visual representation and a new at least one insurance policy quote; and
transmitting the new at least one visual representation and the new at least one insurance policy quote to the user device.

20. The computer program product according to claim 15, wherein the user interface includes at least one of the following: a data describing the object, a data describing at least attribute in the plurality of attributes, a graphical representation of the object, a graphical representation of at least one attribute in the plurality of attributes, a video illustrating the object and/or at least one attribute in the plurality of attributes, a narrative textual data describing the object, and any combination thereof.

21. The computer program product according to claim 15, wherein the transmitting of at least one visual representation includes transmitting at least one option for obtaining additional insurance coverage for the object.
